(19) United States
(12) Patent Application Publication
(10) Pub. No.: US 2026/0059253 A1
(43) Pub. Date: Feb. 26, 2026

(54) Spatial Sound Image Correction In A Vehicle

(71) Applicant: iBiquity Digital Corporation, Columbia, MD (US)

(72) Inventor: Daekyoung Noh

(21) Appl. No.: 19/102,915

(22) PCT Filed: Aug. 10, 2023
(86) PCT No.: PCT/US2023/029952

§ 371 Date: Feb. 11, 2025

Related U.S. Application Data
(60) Provisional application No. 63/397,766, filed on Aug. 12, 2022.

(51) Int. Cl. H04S 7/00

(52) U.S. Cl. CPC H04S 7/301; H04S 7/302; H04S 7/307; H04R 2499/13; H04S 2420/01

(57) ABSTRACT

Generally disclosed herein is a system and method for correcting an audio spatial image within a vehicle. The gain and the delay of sound sources, such as speakers within a vehicle, are adjusted such that the sound sources arrive at a listener simultaneously and with the same amplitude. Symmetric output channel pairs may be identified from the sound sources, and power spectrum differences between the symmetric output channel pairs may be computed. A power spectrum equalization transfer function may be obtained and applied to each output channel pair. A center image of the sound sources may be detected, and the center image of the sound sources may be adjusted by applying additional amplitude or phase panning such that the center image may be placed in a desired position.

### BACKGROUND

The automotive acoustic environment exhibits discernable distinctions from other types of enclosed spaces for audio playback. For example, the speakers in a vehicle are positioned asymmetrically with respect to the driver in a driver's seat or the passenger in a passenger seat. Listeners in the driver or the passenger seat are typically fixed in their respective seats, and therefore, they are not positioned on the symmetric center of the overall vehicle speaker system. Moreover, since distances between left-side and right-side speakers and the driver differ from distances between the left-side and right-side speakers and passengers, the sound image may be formed leaning to one side, and thus, cause the driver and passenger to experience sound image localization errors or ambiguity.

Certain techniques have been developed to adjust the amplitude and time delay of the speaker system to correct the sound image to the user's desired or intended locations. However, adjusting the amplitude and time delay alone cannot address the spectral imbalance between the lateral output channels. The atypical direct or reflective path energy ratio in the vehicle may cause a spectral imbalance. Additionally, the dissimilarity of the head-related transfer functions (HRTF) from the asymmetric speaker positions can also contribute to the spectral imbalance.

### BRIEF SUMMARY

Generally disclosed herein is a mechanism to correct an audio spatial image within a vehicle. The gain and the delay of sound sources, such as speakers within a vehicle, are adjusted such that the sound sources arrive at a listener simultaneously and with the same amplitude. Symmetric output channel pairs, with respect to the center of the vehicle, may be identified from the speakers in the vehicle, and power spectrum differences between the symmetric output channel pairs may be computed. A power spectrum equalization transfer function may be obtained and applied to each output channel pair. A center sound image may be detected or obtained from the audio input signals, and the center sound image location may be adjusted by applying additional amplitude or phase panning such that the center image may be placed in a desired position.

An aspect of the disclosure provides a method for spatial sound image correction in a vehicle. The method includes detecting an amplitude and a time delay of two or more speakers, each speaker playing back one or more output channels; aligning the amplitude and the time delay of the two or more speakers; capturing a frequency spectrum of each output channel of the two or more speakers, wherein each output channel of a first speaker has a symmetrical output channel which is one of the one or more output channels of a second speaker; analyzing power spectrum differences between each output channel of the first speaker and each symmetrical output channel of the second speaker; computing a power spectrum equalizer transfer function for each symmetrical output channel pair; and applying the power spectrum equalizer transfer function to each output channel of the two or more speakers.

In another example, the method further includes detecting a center sound image based on sound sources from the two or more speakers; and applying an additional amplitude panning to the center sound image to locate the center sound image to a user's desired position.

Another aspect of the disclosure provides a system for spatial image correction in a vehicle. The system includes memory and one or more processors in communication with the memory and configured to receive a detected amplitude and time delay of two or more speakers, each speaker playing back one or more output channels; receive a captured frequency spectrum of each output channel of the two or more speakers, wherein each output channel of a first speaker has a symmetrical output channel which is one of the one or more output channels of a second speaker; receive analyzed power spectrum differences between each output channel of the first speaker and each symmetrical output channel of the second speaker;
receive a computed power spectrum equalizer transfer function for each symmetrical output channel pair; align the amplitude and the time delay of the two or more speakers; receive a power spectrum equalizer transfer function for each symmetrical output pair; and apply the power spectrum equalizer transfer function to each output channel of the two or more speakers in the vehicle, the power spectrum equalizer transfer function derived by a process comprising: capturing a frequency spectrum of each output channel of the two or more speakers, wherein each output channel of a first speaker has a symmetrical output channel which is one of the one or more output channels of a second speaker; analyzing power spectrum differences between each output channel of the first speaker and each symmetrical output channel of the second speaker; and computing a power spectrum equalizer transfer function for each symmetrical output channel pair.

In another example, the one or more processors are further configured to detect a center sound image based on sound sources from the two or more speakers; and apply an additional amplitude panning to the center sound image to locate the center sound image to a user's desired position.

Another aspect of the disclosure provides a non-transitory machine-readable medium comprising machine-readable instructions encoded thereon for performing a method of spatial sound image correction. The method includes detecting an amplitude and a time delay of two or more speakers, each speaker playing back one or more output channels; aligning the amplitude and the time delay of the two or more speakers; capturing a frequency spectrum of each output channel of the two or more speakers, wherein each output channel of a first speaker has a symmetrical output channel which is one of the one or more output channels of a second speaker; analyzing power spectrum differences between each output channel of the first speaker and each symmetrical output channel of the second speaker; computing a power spectrum equalizer transfer function for each symmetrical output channel pair; and applying the power spectrum equalizer transfer function to each output channel of the two or more speakers.

The above and other aspects of the disclosure can include one or more of the following features. In some examples, aspects of the disclosure provide for all of the following features in combination.

In another example, the power spectrum equalizer transfer function is computed using a pre-measured frequency response of each output channel of the two or more speakers.

In yet another example, the power spectrum equalizer transfer function is computed using pre-measured head-related transfer function (HRTF) data based on an azimuth, elevation angle or location in 3D coordinates of the two or more speakers.

In yet another example, the power spectrum equalizer transfer function is computed using modeled HRTF data based on an azimuth, elevation angle or location in 3D coordinates of the two or more speakers.

In yet another example, the power spectrum equalizer transfer function is complementary for each symmetrical output channel.

In yet another example, the power spectrum equalizer transfer function is computed based on head position and rotation information using one or more sensors.

In yet another example, the one or more sensors include one or more cameras equipped within the vehicle.

In yet another example, the center sound image is clarified using an additional equalizer.

### BRIEF DESCRIPTION OF THE DRAWINGS

FIGS. 1A-1B depict a block diagram illustrating a vehicle speaker system and phantom center localization according to aspects of the disclosure.

FIGS. 2A-2C depict a block diagram illustrating psychoacoustic errors in the left and the right sound source perception in a vehicle according to aspects of the disclosure.

FIG. 3A depicts a graph illustrating a power spectrum captured using a left and right side of a dummy head within a vehicle according to aspects of the disclosure.

FIG. 3B depicts a graph illustrating a power spectrum equalizer filter response based on the power spectrum captured using the dummy head according to aspects of the disclosure.

FIG. 4 depicts a flow diagram illustrating an example power spectrum equalizer design method according to aspects of the disclosure.

FIG. 5 depicts a block diagram illustrating an example power spectrum equalization and gain/delay adjustment processing for stereo signal according to aspects of the disclosure.

FIG. 6 depicts a block diagram illustrating an example center reposition module for multiple input audio signals according to aspects of the disclosure.

FIG. 7 depicts a block diagram illustrating an example spatial image correction in a vehicle according to aspects of the disclosure.

FIG. 8 depicts a block diagram illustrating an example automotive spatial image correction system according to aspects of the disclosure.

### DETAILED DESCRIPTION

Generally disclosed herein is a system and method for automatically correcting spectral imbalance between two or more speakers outputting multiple lateral output channels within a vehicle. The gain and the delay of the sound outputs from the speakers may be aligned. Symmetric output channel pairs may be identified from the speaker layout of the vehicle. For example, a first speaker may have a first channel output, and a second speaker may have a second channel output, wherein the first channel output and second channel output are laterally symmetrical pairs. Power spectrum differences between a first output channel pair from the first speaker and second output channel pair from the second speaker may be computed. Power spectrum equalization transfer functions may be obtained based on the power spectrum differences of the symmetric output channel pairs. The power spectrum equalization transfer functions may be applied to the sound output channels. The sound image of the sound outputs can be further adjusted to a user's desired position by adopting selective equalization and amplitude and/or time delay alignment.

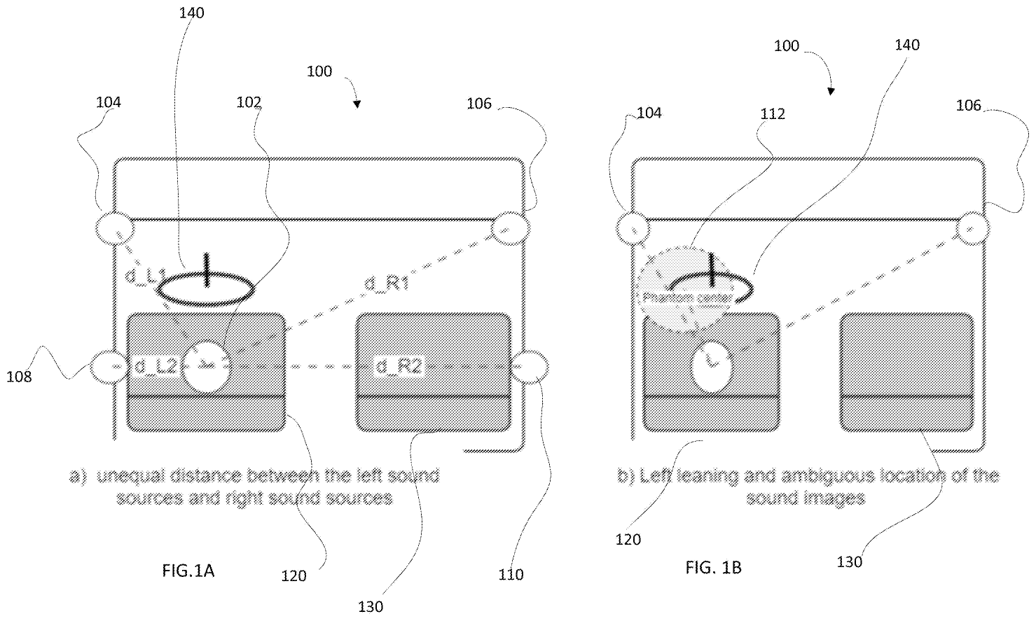

FIGS. 1A-1B depicts a block diagram illustrating a vehicle speaker system and phantom center localization. Vehicle 100 may include an interior cabin equipped with driver seat 120, passenger's seat 130 and steering wheel 140. In the present examples, the driver seat 120 is on the left side of vehicle 100 and the passenger seat 130 is on the right side. It is to be understood that the above arrangement may differ in other vehicles.

FIG. 1A illustrates unequal distances between the left sound sources and the right sound sources within vehicle 100. Vehicle 100 may be equipped with four speakers: speakers 104-110. Speakers 104 and 108 are located on the left side of the vehicle and speakers 106 and 110 are located on the right side of the vehicle. In this example, user 102 is a driver sitting in the driver's seat 120. Since user 102 is positioned toward the left side of the vehicle, the distance d_L1 between speaker 104 and user 102 is shorter than the distance d_R1 between speaker 106 and user 102. Likewise, the distance d_L2 between speaker 108 and user 102 is shorter than the distance d_R2 between speaker 110 and user 102.

Referring to FIG. 1B, because of the distance differences between the left and the right-side speakers to user 102, a sound image may be formed leaning to one side. A sound image may refer to a user's perceived spatial location of a sound source. The sound image may be ambiguous in its location, for example, if the sound from the two sides does not arrive at the user simultaneously and the difference between a first arrival time when sound from the left speaker arrives and a second arrival time when sound from the right speaker arrives is greater than a certain time value. For example, localization ambiguity may occur when the above difference between arrival times is greater than 3 ms and less than 15 ms. Due to the above discrepancies, a phantom center 112 may be formed toward the left side of user 102. The phantom center may refer to a psycho-acoustic phenomenon of a sound source appearing to emanate from a point between at least two speakers. For the purpose of this disclosure, a psycho-acoustic may refer to any type of scientific study of sound perception and audiology.

Gain and delay adjustment may correct or adjust the sound images to the desired or intended location. For example, if the gain of right speaker 106 is increased to match the gain of left speaker 104 and the delay of left speaker 104 is matched to that of right speaker 106, phantom center 112 may move to the right side to be positioned in the middle of the location where the wheel is located. However, since the environment in the vehicle is a confined environment and each sound source may reflect off surfaces of various objects in the vehicle in a variety of ways, adjusting the gain and the delay of the direct sound source may not be sufficient to correct the sound localization errors or ambiguity.

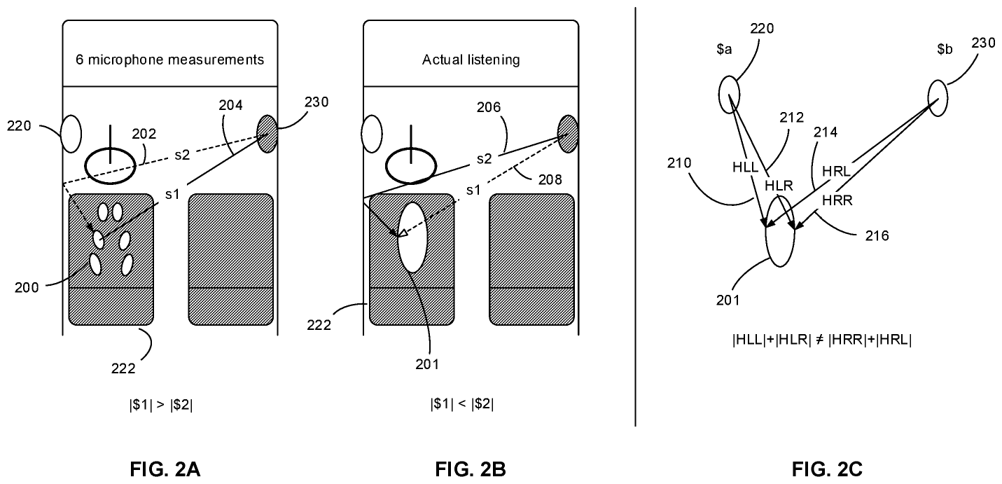

FIG. 2A illustrates the sound energy of direct and reflected sound using microphone measurements. The reflected sound may refer to a sound reflected from the surface of any object. In the example shown, six microphones are attached to a driver's seat and one of the six microphones, microphone 200, may be used to measure the energy of the sound output from right-side speaker 230. For example, two different sound energy measurements may be detected using microphone 200. The direct sound 204 and the reflected sound 202 may be measured and compared. The reflected sound 202 may reflect off a driver-side window. Since the reflected sound 202 arrives later than the direct sound 204, the energy (S1) of the direct sound 204 may be lower than the energy (S2) of the reflected sound 202. In other examples, a different number of microphones may be used.

Referring to FIG. 2B, user 201 is seated in the driver's seat 222 and the reflected sound 206 and the direct sound 208 are measured. In this example, unlike the conventional microphone measurements where a microphone is arrayed without a head and torso, the head of user 201 may attenuate the direct sound 208 with respect to the left ear of user 201. Since the right side of the head of user 201 may block the path of the direct sound 208, the energy of the direct sound 208 measured at the left ear of user 201 may be lower than the energy of the reflected sound 206 measured at the left ear of user 201. Furthermore, an azimuth difference between the left-side and the right-side speakers to user 201 may cause a spectral imbalance between the left and right sounds. The azimuth may refer to the angle between the sound or response location, the center of the head of user 201, and the median plane in front of the head of user 201. The spectral imbalance may refer to an imbalanced distribution of sound energy between the left ears and right ears of listeners.

Referring to FIG. 2C, the timbre difference and sound image split caused by the frequency spectrum differences are illustrated. Timbre may refer to a perceived sound quality of musical sound or tone. The head-related transfer function (HRTF) may vary for the different locations of the sound with respect to user 201. The HRTF may refer to a transfer function that describes how a sound from a specific point arrives at the ear of user 201. Sound 210 (HLL) and 212 (HLR) are outputs from the left-side speaker 220. Sound 214 (HRL) and 216 (HRR) are output from the right-side speaker 230. Since the total energy of sounds 210 and 212 is not equal to the total energy of sounds 214 and 216, the amplitude and time delay alignment of the left-side and right-side speakers in FIG. 2C may be insufficient for resolving the perceived timbre difference and the sound image split.

According to some embodiments, a power spectrum equalization (PSE) may be performed to compensate for the above-described frequency spectrum differences between the left-side speaker 220 and right-side speaker 230. The HRTF may be measured using a dummy head or a human in a vehicle or obtained using modeling (e.g., spherical head model). In one example, the power sum of the ipsilateral and contralateral HRTFs as shown in the equations below may be used to correct the perceived timbre differences illustrated in FIG. 2C.

$$Hpse\_L = ( \vert HRR \vert + \vert HRL \vert ) / ( \vert HLL \vert + \vert HLR \vert ) \qquad Equation 1$$

$$Hpse\_R = ( \vert HLL \vert + \vert HLR \vert ) / ( \vert HRR \vert + \vert HRL \vert ) \qquad Equation 2$$

Equations 1 and 2 may represent the power spectrum difference between the left-side and right-side sounds. According to some examples, only one of the above two equations may be applied to the right/left audio channel audio since both equations 1 and 2 represent the entire frequency spectrum differences.

According to some embodiments, an equalizer (EQ) may be applied to the right channel audio as represented in the equation below.

$$HLout = HLin * {Z}^{- m} , HRout = HRin * Hpse , \qquad Equation 3$$

Z represents an equalizer and “m” may refer to the time delay in a sample from a PSE filter.

According to some embodiments, a power-preserved EQ may be used instead of an original EQ. If the original EQ is applied to one channel, energies may be subtracted from or added to different frequency bins where the overall timbre is not preserved relative to the sound that is not equalized. The power-preserved EQ is applied using the following equations.

$$HLout = HLin * \sqrt{Hpse\_L} \qquad Equation 4$$

$$HRout = HRin * \sqrt{Hpse\_R} \qquad Equation 5$$

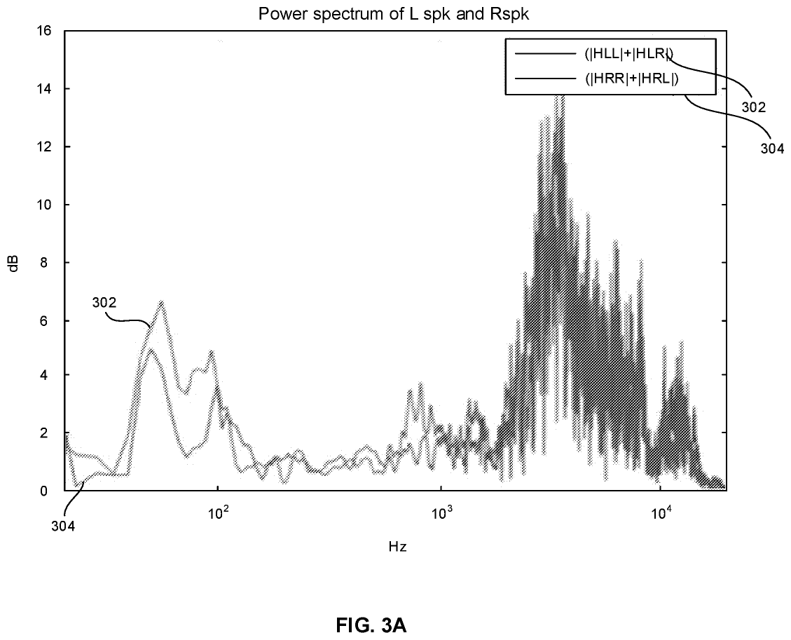

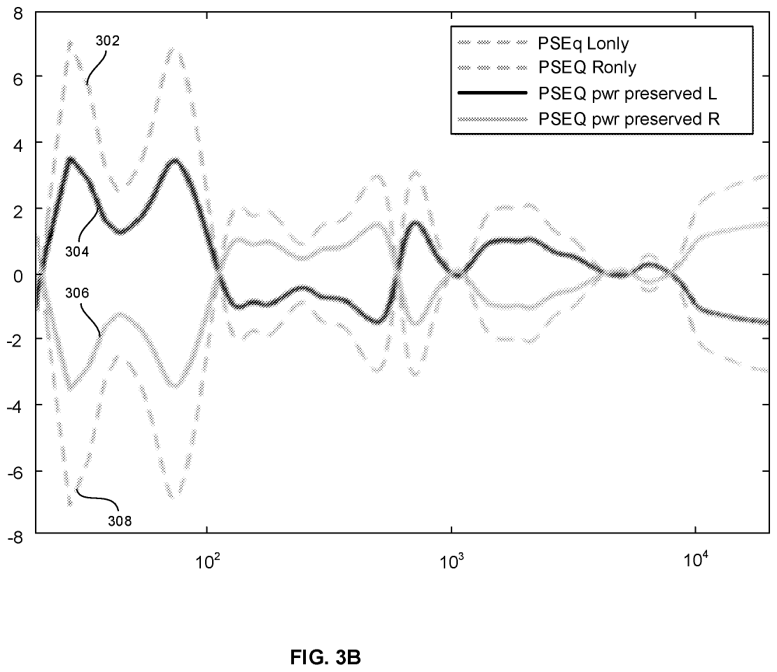

FIG. 3A depicts a graph illustrating a power spectrum of left-side and right-side speakers. Graph line 302 represents the power spectrum of the left-side speaker and graph line 204 represents the power spectrum of the right-side speaker. As illustrated in the graph, the discrepancies between the power spectrum of the left-side and right-side speakers are noticeable.

FIG. 3B depicts a graph illustrating power spectrum equalizer filter responses. Graph line 302 represents the power spectrum with an EQ applied to the left-side speaker only. Graph line 304 represents the power spectrum with a power-preserved EQ applied to the left-side speaker only. Graph line 306 represents the power spectrum with a power-preserved EQ applied to the right-side speaker only. Because the different combinations of filtering effects may be caused by the various time delays due to the reflections of the sound from the left-side and right-side speaker, the power spectrum equalizer may be smoothed as illustrated by graph line 304 and 306. The PSEQ represented by graph lines 302 or 308 may not be applied at the same time. However, both the power-preserved PSEQ 304 and 306 may be applied to the left-side and right-side speakers.

According to some embodiments, multiple microphone measurements may be utilized such that the multiple measurements can average the sound power measured at listeners' various head positions. The PSE can be measured and modeled in a similar way such that multiple locations of the user's head can be averaged to minimize the listener's position-based errors. In another example, the head position and rotation information may be captured using a variety of sensors such as event cameras to apply the PSE to sound captured at the given head portions to further optimize the PSE.

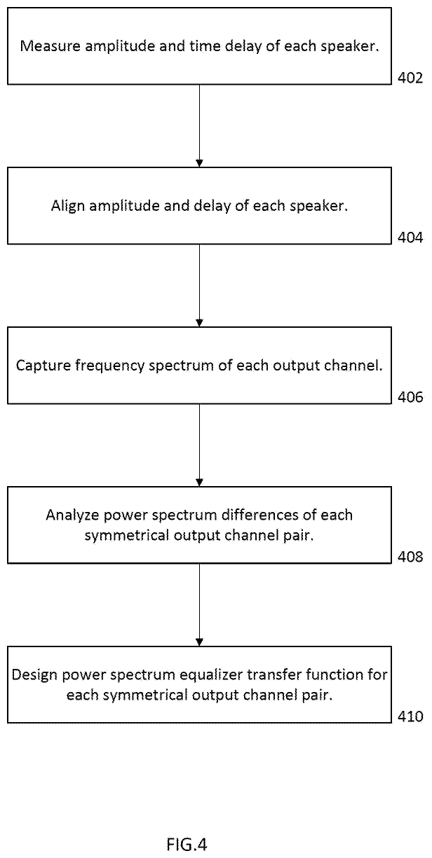

FIG. 4 depicts a flow diagram illustrating an example power spectrum equalizer design method. According to block 402, the amplitude and time delay of sound from two or more speakers are measured. According to some embodiments, the automotive spatial image correction system may include two or more speakers equipped within the vehicle. A driver and a passenger may sit in the driver's seat and the passenger's seat, respectively. The location of the driver's seat or passenger's seat may not be laterally adjustable. The distance between the left-side speaker and the driver or passenger and the distance between the right-side speaker and the driver or passenger may differ.

According to block 404, the amplitude and time delay of the sound from two or more speakers may be aligned. Since the distances between the left-side speaker and the driver/passenger and the distance between the right-side speaker and the driver/passenger are different, the sound from the left-side speaker and the sound from the right-side speaker does not arrive at the driver/passenger's ear at the same time.

According to block 406, the frequency spectrum of each output channel from two or more speakers is captured. Each speaker may output one or more different sound channels. For example, the left front channel (input signal) may be played back by the left door speaker(s) as well as the rear left seat door speaker(s). The passengers in the back seat may need to hear the front sound. At the same time, the left rear door speaker(s) can also play the left sound channel (input).

According to block 408, the power spectrum differences of each symmetrical sound channel pair are analyzed. For example, direct sound from a left-side speaker reaches two ears of the listener; one is directed to the right ear of the driver/passenger, and the other is directed to the left ear of the driver/passenger. The right-side speaker also outputs sound directed to each ear of the driver/passenger. The sum of the power spectrum may be identified by grouping the sound from the left-side speaker directed to each ear of the driver/passenger with the sound from the right-side speaker directed to each ear of the driver/passenger, and vice versa.

According to block 410, the power spectrum equalizer transfer function for each symmetrical output channel pair is designed. According to some embodiments, the power spectrum equalization (PSE) may be performed using the HRTF data to compute the equalization transfer function. In an example, the power sum of the sound channels of one side of the speaker is divided by the power sum of the sound channels of the other side of the speaker. According to some embodiments, the power-preserved EQ may be applied by taking the square root of the aforementioned PSE to one of the sound channels.

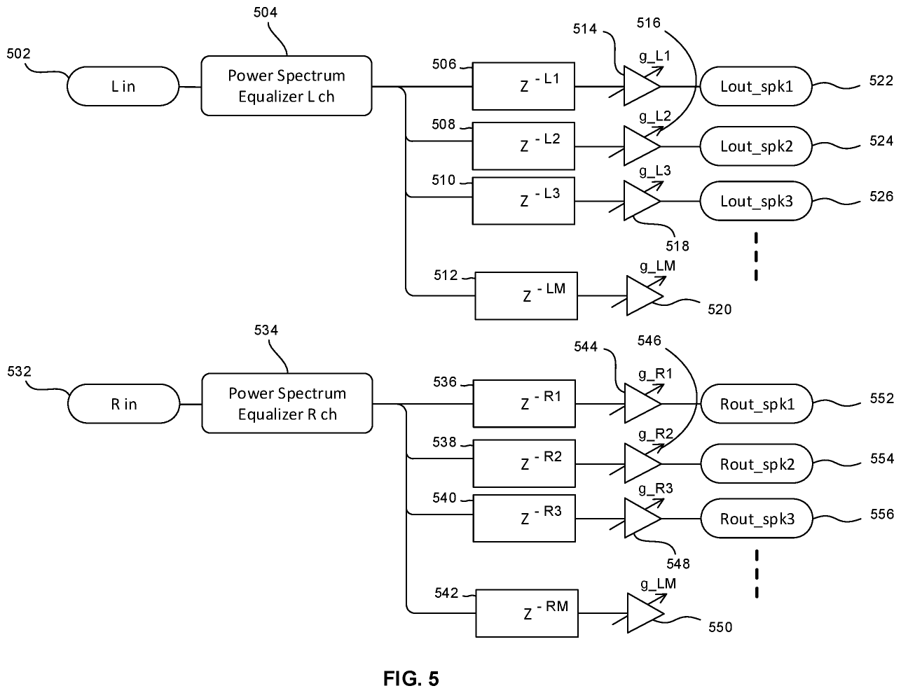

FIG. 5 depicts a block diagram illustrating an example power spectrum equalization and gain/delay adjustment processing for the stereo signal. According to some embodiments, the spatial image correction processing may be a cascaded process of the PSE and the amplitude and time delay alignment. Since they are all linear-time-invariant (LTI) processing, the outcome may be the same even if the processing order is changed. For example, the automotive spatial image correction system may include a right-side and left-side speaker. The left-side speaker may include left channel audio signal input 502, left channel PSE 504, left channel delay lines 506-512, left channel gain lines 514-520, and left channel outputs 522-526. The right-side speaker may include right channel audio signal input 532, right channel PSE 534, right channel delay lines 536-542, right channel gain lines 544-550, and right channel outputs 552-556. The right and left channel audio signal input may be divided into multiple sound channels. Each sound channel may correspond to one of the different sound components. The gain and the time delay of each channel may be adjusted individually. For example, each of the delay lines 506-512 and 536-542 may adjust the time delay of each sound channel. Likewise, the gains of each sound channel may be adjusted individually. Gain lines 514-520 and 544 and 550 may adjust the gains of each sound channel.

According to some embodiments, right and left PSE may be applied to each of the left or right sound channel outputs 522-526 and 552-556 or applied to the left and right audio signal inputs 502 and 532 before each channel is distributed to each delay and gain lines. The illustrated power spectrum equalization processing is linear-time-invariant processing, and thus, the outcome is identical even if the processing order is changed.

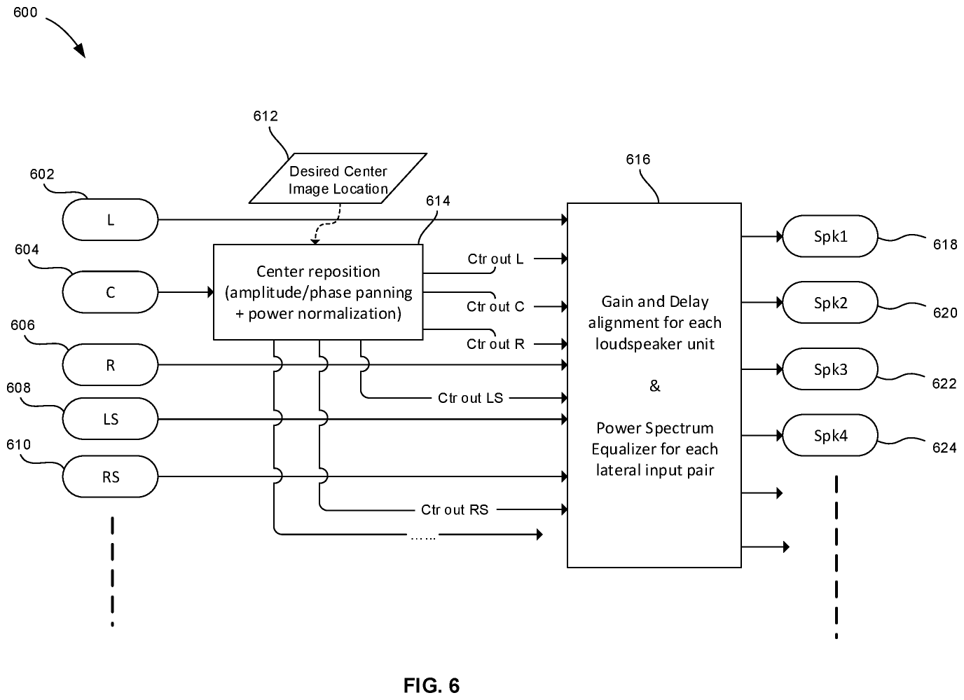

FIG. 6 depicts a block diagram illustrating an example center reposition module 600 for multiple input audio signals. According to some embodiments, the PSE and the amplitude and time delay alignment may allow the center image location to be adjusted in a vehicle. Even with a center speaker in the vehicle, the center image may not be adjusted effectively only by utilizing the amplitude panning method because of the asymmetric loudspeaker location and unbalanced frequency spectrum of the left and right sound perceived by a driver/passenger. The center sound image may be modified to be located at the driver/passenger's preferred location by applying a sound source panning combined with the PSE and the amplitude and time delay alignment.

The center reposition module may include a 5.1 surround sound system. The 5.1 surround sound system may include five sound channels: left sound channel 602, center sound channel 604, right sound channel 606, left-surround sound channel 608, and right-surround sound channel 610. The center reposition module 600 may receive the driver/passenger's desired center image location 612 via a graphical user interface on an electronic device communicable with the vehicle's stereo system, such as a smartwatch, smartphone, or tablet. Once the center reposition module 600 receives the user's desired center image location 612, the center image may be repositioned using amplitude/phase panning and power normalization. Once the center image is repositioned to center reposition 614, the center reposition may be divided into center-left, center-center, center-right, center-left surround, and center-right surround channels and distributed to gain and delay alignment unit 616. Gain and delay alignment unit 616 may perform gain and delay alignment and apply the PSE for each sound channel and send the modified sound channels to speakers 618-624. Gain and delay alignment unit 616 may receive not only center repositioned channels but also receive original and unmodified sound channels such as left sound channel 602, right sound channel 606, left surround sound channel 608, and right surround sound channel 610.

According to some embodiments, the center image may be repositioned using additional power normalization applied to a conventional audio source panning. Audio source panning may refer to the distribution of the sound across the stereo or surround spectrum to create a balanced sound. Since the panned center image may reside in the stereo mix with the original panning, the gain from the original panning must be removed before repositioning the center image. For example, the panned center output level may be 3 dB lower than the original signal's output level as the original panning may further reduce the center sound source in the left and right sound channel levels by 3 dB even though they were already reduced by 3 dB during the original mixing stage. The normalization process may be performed using the equations below.

$$L\_c = cos ( 45 ) * C and R\_c = sin ( 45 ) * C \qquad Equation 6$$

The above equation provides the already panned phantom center by setting the originally adjusted center location as 0 degrees. The re-panned left sound channel and right sound channel may be expressed as follows:

$${L\_c}^{′} = norm\_coeff * cos ( 45 + alpha ) * L\_c , where alpha is an angle from the speaker ’ s center location with the range of = / - 45 degrees . \qquad Equation 7$$

$${R\_c}^{′} = norm\_coeff * sin ( 45 + alpha ) * R\_c \qquad Equation 8$$

If alpha is 0 degrees, the norm_coeff becomes 1/cos(45) or 1/sin(45).

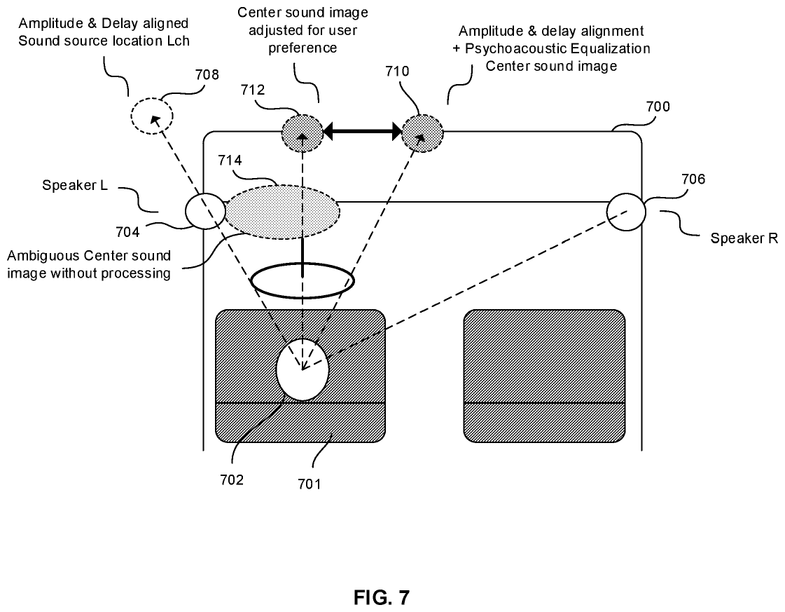

FIG. 7 depicts a block diagram illustrating an example spatial image correction in a vehicle. User 702 is a driver seated in driver's seat 701. The Vehicle 700 is equipped with a left-side speaker 704 and a right-side speaker 706. Without an amplitude and delay alignment, the center image 714 is located on the left side of the vehicle close to the left-side speaker 704. If the automotive spatial image correction system aligns the amplitude, time delay and power spectrum equalization of the sound from left-side speaker 704 and right-side speaker 706, the center image 714 may be moved to the position where the adjusted center image 710 is formed. As illustrated in FIG. 6, the center reposition module 600 may receive the user's desired center image information and reposition the center image 710 to repositioned center image 712 based on amplitude/phase panning and power normalization of the sound.

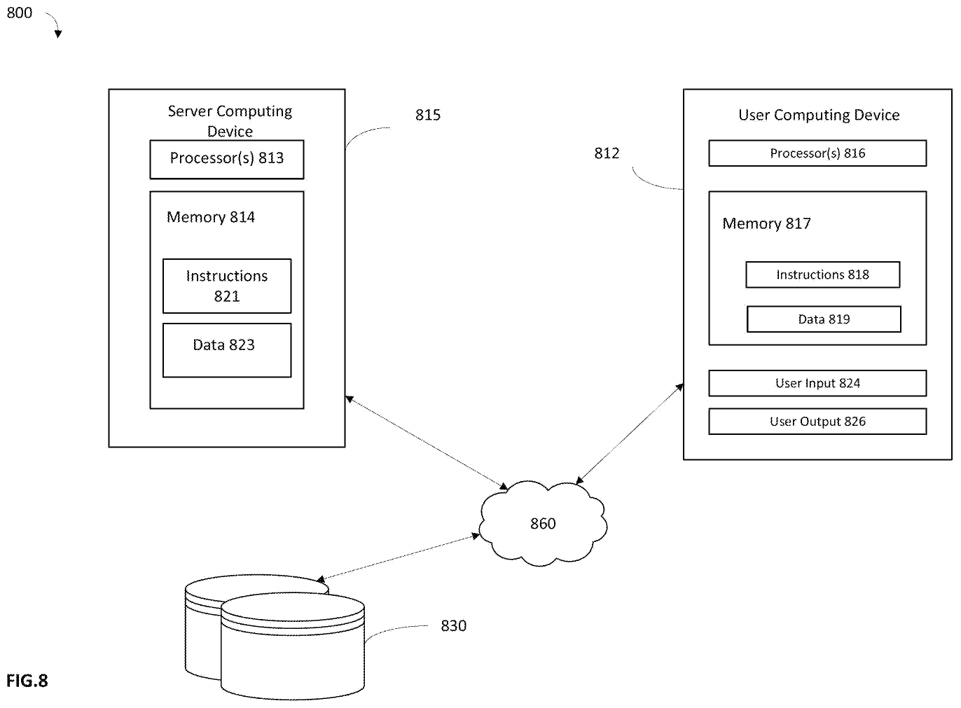

FIG. 8 depicts a block diagram of an example automotive spatial image correction system. User computing device 812 and server computing device 815 can be communicatively coupled to one or more storage devices 830 over a network 860. The storage device(s) 830 can be a combination of volatile and non-volatile memory and can be at the same or different physical locations than the computing devices 812, 815. For example, the storage device(s) 830 can include any type of non-transitory computer-readable medium capable of storing information, such as a hard drive, solid-state drive, tape drive, optical storage, memory card, ROM, RAM, DVD, CD-ROM, write-capable, and read-only memories. User computing device 812 may be attached to a vehicle and communicable with the vehicle's stereo system to control output sound channels from two or more speakers in the vehicle.

The server computing device 815 can include one or more processors 813 and memory 814. Memory 814 can store information accessible by the processor(s) 813, including instructions 821 that can be executed by the processor(s) 813. Memory 814 can also include data 823 that can be retrieved, manipulated, or stored by the processor(s) 813. Memory 814 can be a type of non-transitory computer-readable medium capable of storing information accessible by the processor(s) 813, such as volatile and non-volatile memory. The processor(s) 813 can include one or more central processing units (CPUs), graphic processing units (GPUs), field-programmable gate arrays (FPGAs), and/or application-specific integrated circuits (ASICs), such as tensor processing units (TPUs).

Instructions 821 can include one or more instructions that when executed by the processor(s) 813, cause one or more processors to perform actions defined by the instructions. Instructions 821 can be stored in object code format for direct processing by the processor(s) 813, or in other formats including interpretable scripts or collections of independent source code modules that are interpreted on demand or compiled in advance. Instructions 821 can include instructions for implementing processes consistent with aspects of this disclosure. Such processes can be executed using the processor(s) 813, and/or using other processors remotely located from the server computing device 815.

The data 823 can be retrieved, stored, or modified by processor(s) 813 in accordance with instructions 821. Data 823 can be stored in computer registers, in a relational or non-relational database as a table having a plurality of different fields and records, or as JSON, YAML, proto, or XML documents. Data 823 can also be formatted in a computer-readable format such as, but not limited to, binary values, ASCII, or Unicode. Moreover, data 823 can include information sufficient to identify relevant information, such as numbers, descriptive text, proprietary codes, pointers, references to data stored in other memories, including other network locations, or information that is used by a function to calculate relevant data.

User computing device 812 can also be configured similarly to the server computing device 815, with one or more processors 816, memory 817, instructions 818, and data 819. The user computing device 812 can also include a user output 826, and a user input 824. The user input 824 can include any appropriate mechanism or technique for receiving input from a user, such as a keyboard, mouse, mechanical actuators, soft actuators, touch screens, and microphones. User computing device 812 may send a user's preferred location of a sound image via a graphical user interface on a display.

Server computing device 815 can be configured to transmit data to the user computing device 812, and the user computing device 812 can be configured to display at least a portion of the received data on a display implemented as part of the user output 826. The user output 826 can also be used for displaying an interface between the user computing device 812 and the server computing device 815. For example, if user computing device 812 sends the user's preferred location information to server computing device 815, server computing device 813 sends information as to appropriate gain and delay levels of each of two more output channels of the speakers. Once user computing device 812 receives said information from server computing device 815, user computing device 812 may adjust or modify the gain and delay level of one or more sound output channels to adjust the location of the sound image. In some examples, the user output 826 can alternatively or additionally include one or more speakers, transducers, or other audio outputs, a haptic interface, or other tactile feedback that provides non-visual and non-audible information to the platform user of the user computing device 812.

Although FIG. 8 illustrates the processors 813, 816 and the memories 814, 817 as being within the computing devices 815, 812, components described in this specification, including the processors 813, 816 and the memories 814, 817 can include multiple processors and memories that can operate in different physical locations and not within the same computing device. For example, some of instructions 821, 818, and data 823, and 819 can be stored on a removable SD card and others within a read-only computer chip. Some or all of the instructions and data can be stored in a location physically remote from, yet still accessible by, the processors 813, 816. Similarly, processors 813, and 816 can include a collection of processors that can perform concurrent and/or sequential operations. Computing devices 815, and 812 can each include one or more internal clocks providing timing information, which can be used for time measurement for operations and programs run by computing devices 815, and 812.

Devices 812, and 815 can be capable of direct and indirect communication over network 860. Devices 812, and 815 can set up listening sockets that may accept an initiating connection for sending and receiving information. The network 860 itself can include various configurations and protocols including the Internet, World Wide Web, intranets, virtual private networks, wide area networks, local networks, and private networks using communication protocols proprietary to one or more companies. Network 860 can support a variety of short- and long-range connections. The network 860, in addition, or alternatively, can also support wired connections between devices 812, and 815, including over various types of Ethernet connection.

Although a single server computing device 815 and user computing device 812 are shown in FIG. 8, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method for spatial sound image correction in a vehicle, the method comprising:
detecting an amplitude and a time delay of two or more speakers, each speaker playing back one or more output channels;
aligning the amplitude and the time delay of the two or more speakers;
capturing a frequency spectrum of each output channel of the two or more speakers, wherein each output channel of a first speaker has a symmetrical output channel which is one of the one or more output channels of a second speaker;
analyzing power spectrum differences between each output channel of the first speaker and each symmetrical output channel of the second speaker;
computing a power spectrum equalizer transfer function for each symmetrical output channel pair; and
applying the power spectrum equalizer transfer function to each output channel of the two or more speakers.

2. The method of claim 1, wherein the power spectrum equalizer transfer function is computed using a pre-measured frequency response of each output channel of the two or more speakers.

3. The method of claim 1, wherein the power spectrum equalizer transfer function is computed using pre-measured head-related transfer function (HRTF) data based on an azimuth, elevation angle, or location in 3D coordinates of the two or more speakers.

4. The method of claim 1, wherein the power spectrum equalizer transfer function is computed using modeled HRTF data based on an azimuth, elevation angle or location in 3D coordinates of the two or more speakers.

5. The method of claim 1, wherein the power spectrum equalizer transfer function is complementary for each symmetrical output channel pair.

6. The method of claim 1, wherein the power spectrum equalizer transfer function is computed based on head position and rotation information using one or more sensors.

7. The method of claim 6, wherein the one or more sensors include one or more cameras equipped within the vehicle.

8. The method of claim 1, further comprising:
detecting a center sound image based on sound sources from the two or more speakers; and
applying an additional amplitude panning to the center sound image to locate the center sound image to a user's desired position.

9. The method of claim 8, wherein the center sound image is clarified using an additional equalizer.

10. A system for spatial sound image correction in a vehicle, the system comprising:
memory; and
one or more processors in communication with the memory and configured to:
receive a detected amplitude and time delay of two or more speakers, each speaker playing back one or more output channels;
receive a captured frequency spectrum of each output channel of the two or more speakers, wherein each output channel of a first speaker has a symmetrical output channel which is one of the one or more output channels of a second speaker;
receive analyzed power spectrum differences between each output channel of the first speaker and each symmetrical output channel of the second speaker;
receive a computed power spectrum equalizer transfer function for each symmetrical output channel pair;
align the amplitude and the time delay of the two or more speakers;
receive a power spectrum equalizer transfer function for each symmetrical output pair; and
apply the power spectrum equalizer transfer function to each output channel of the two or more speakers in the vehicle, the power spectrum equalizer transfer function derived by a process comprising:
capturing a frequency spectrum of each output channel of the two or more speakers, wherein each output channel of a first speaker has a symmetrical output channel which is one of the one or more output channels of a second speaker;
analyzing power spectrum differences between each output channel of the first speaker and each symmetrical output channel of the second speaker; and
computing a power spectrum equalizer transfer function for each symmetrical output channel pair.

11. The system of claim 10, wherein the power spectrum equalizer transfer function is computed using a pre-measured frequency response of each output channel of the two or more speakers.

12. The system of claim 10, wherein the power spectrum equalizer transfer function is computed using pre-measured head-related transfer function (HRTF) data based on an azimuth, elevation angle or location in 3D coordinates of the two or more speakers.

13. The system of claim 10, wherein the power spectrum equalizer transfer function is computed using modeled HRTF data based on an azimuth, elevation angle or location in 3D coordinates of the two or more speakers.

14. The system of claim 10, wherein the power spectrum equalizer transfer function is complementary for each symmetrical output channel.

15. The system of claim 10, wherein the power spectrum equalizer transfer function is computed based on head position and rotation information using one or more sensors.

16. The system of claim 15, wherein the one or more sensors include one or more cameras equipped within the vehicle.

17. The system of claim 10, wherein the one or more processors are further configured to:
detect a center sound image based on sound sources from the two or more speakers; and
apply an additional amplitude panning to the center sound image to locate the center sound image to a user's desired position.

18. The system of claim 17, wherein the center sound image is clarified using an additional equalizer.

19. A non-transitory machine-readable medium comprising machine-readable instructions encoded thereon for performing a method of spatial sound image correction, the method comprising:
detecting an amplitude and a time delay of two or more speakers, each speaker playing back one or more output channels;
aligning the amplitude and the time delay of the two or more speakers;
capturing a frequency spectrum of each output channel of the two or more speakers, wherein each output channel of a first speaker has a symmetrical output channel which is one of the one or more output channels of a second speaker;
analyzing power spectrum differences between each output channel of the first speaker and each symmetrical output channel of the second speaker;
computing a power spectrum equalizer transfer function for each symmetrical output channel pair; and
applying the power spectrum equalizer transfer function to each output channel of the two or more speakers.

20. The non-transitory machine-readable medium of claim 19, wherein the power spectrum equalizer transfer function is computed using modeled HRTF data based on an azimuth, elevation angle or location in 3D coordinates of the two or more speakers.
